(19) United States
(12) Patent Application Publication
(10) Pub. No.: US 2026/0267423 A1
(43) Pub. Date: Sep. 10, 2026

(54) SYSTEMS AND METHODS FOR TRACKING AN INTERACTIVE OBJECT VIA HYPERSPECTRAL IMAGING

(71) Applicant: Universal City Studios LLC, Universal City, CA (US)

(72) Inventors: Wei Cheng Yeh, Orlando, FL (US); Katelyn Wyatt, Orlando, FL (US); McKenna Schwartz, Orlando, FL (US)

(21) Appl. No.: 19/462,505

(22) Filed: Jan. 28, 2026

Related U.S. Application Data
(60) Provisional application No. 63/752,089, filed on Jan. 31, 2025.

(51) Int. Cl. G06F 3/0346; G06F 3/00; G06F 3/01; G06F 3/03; G06T 7/215

(52) U.S. Cl. CPC G06F 3/0346; G06F 3/005; G06F 3/011; G06F 3/0325; G06T 7/215; G06F 3/017; G06T 2207/10036

(57) ABSTRACT

An interactive object control system including processing circuitry comprising one or more processors and memory storing instructions, that when executed by the processing circuitry, cause the processing circuitry to send instructions to activate one or more emitters of an interactive object to emit light and determine an initial position of the interactive object based on hyperspectral data from a hyperspectral imaging system, wherein the hyperspectral data is indicative of detection of the light emitted by the one or more emitters of the interactive object. The memory also includes instructions, that when executed by the processing circuitry, cause the processing circuitry to send instructions to track motion of the interactive object based on additional hyperspectral data from the hyperspectral imaging system, wherein the additional hyperspectral data is indicative of detection of reflected light reflected by one or more detectable markers of the interactive object, and provide output instructions to generate a special effect output based on the motion of the interactive object.

### CROSS-REFERENCE TO RELATED APPLICATION

This application claims priority from and the benefit of U.S. Provisional Application Ser. No. 63/752,089, entitled “SYSTEMS AND METHODS FOR TRACKING AN INTERACTIVE OBJECT VIA HYPERSPECTRAL IMAGING” Filed Jan. 31, 2025, which is hereby incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

To improve guest experiences in an entertainment setting, the entertainment setting may often include objects (e.g., props or toys) that are interactive, provide special effects, or both. For example, the special effects may provide customized effects based on guest experiences within the entertainment setting, as well as support a particular narrative in the entertainment setting. In certain interactive entertainment settings, guests may be associated with objects that interact with the interactive entertainment setting in various ways. In one example, a guest may wish to interact with the interactive entertainment setting using a handheld device (e.g., an object) to generate a particular special effect. However, such interactive entertainment settings are often crowded with multiple guests. As such, identifying objects within such interactive entertainment settings may be challenging when multiple guests are each carrying their own object.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, an interactive object control system including processing circuitry with one or more processors and memory storing instructions, that when executed by the processing circuitry, cause the processing circuitry to send instructions to activate one or more emitters of an interactive object to emit light and determine an initial position of the interactive object based on hyperspectral data from a hyperspectral imaging system, wherein the hyperspectral data is indicative of detection of the light emitted by the one or more emitters of the interactive object. The memory also includes instructions, that when executed by the processing circuitry, cause the processing circuitry to send instructions to track motion of the interactive object based on additional hyperspectral data from the hyperspectral imaging system, wherein the additional hyperspectral data is indicative of detection of reflected light reflected by one or more detectable markers of the interactive object. The memory further includes instructions, that when executed by the processing circuitry, cause the processing circuitry to provide output instructions to generate a special effect output based on the motion of the interactive object.

In an embodiment, a method of operating an interactive object system is provided. The method includes sending instructions to activate one or more emitters of an interactive object to emit light and determining an initial position of the interactive object based on hyperspectral data from a hyperspectral imaging system, wherein the hyperspectral data is indicative of detection of the light emitted by the one or more emitters of the interactive object. The method also includes tracking motion of the interactive object based on additional hyperspectral data from the hyperspectral imaging system, wherein the additional hyperspectral data is indicative of detection of reflected light reflected by one or more detectable markers of the interactive object and providing output instructions to generate a special effect output based on the motion of the interactive object.

In an embodiment, a system is provided. The system includes a hyperspectral imaging system including one or more detectors and an interactive object system including an interactive object, wherein the interactive object comprises one or more detectable markers. The system also includes processing circuitry including one or more processors; and memory storing instructions, that when executed by the processing circuitry, cause the processing circuitry to send instructions to activate one or more emitters to emit light within a spectral signature of the one or more detectable markers. The memory also includes instructions, that when executed by the processing circuitry, cause the processing circuitry to determine an initial position of the interactive object based on hyperspectral data indicative of detected light reflected by the one or more detectable markers, track motion of the interactive object based on additional hyperspectral data generated indicative of the spectral signature of the one or more detectable markers, and provide output instructions to generate a special effect output based on the motion of the interactive object.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an embodiment of an interactive object control system including a hyperspectral imaging system, in accordance with present techniques;

FIG. 2 is a schematic illustration of hardware of an embodiment of the interactive object control system and the hyperspectral imaging system of FIG. 1, in accordance with present techniques;

FIG. 3 is a schematic illustration of an example of hyperspectral data from the hyperspectral imaging system of FIG. 1, in accordance with present techniques;

FIG. 4 is a schematic illustration of an example of a user interface of the hyperspectral imaging system of FIG. 1, in accordance with present techniques; and

FIG. 5 is a flow diagram of an embodiment of a process for detecting an interactive object using the hyperspectral imaging system of FIG. 1, in accordance with present techniques.

### DETAILED DESCRIPTION

The subject matter disclosed herein relates to the field of special effects to enhance guest experiences. More specifically, embodiments of the present disclosure relate to an interactive object control system that includes a hyperspectral imaging system, wherein the interactive object control system and the hyperspectral imaging system may operate to detect one or more interactive objects and to provide special effects based on the one or more interactive objects to enhance guest experiences.

One or more specific embodiments will be described below. In an effort to provide a concise description of these embodiments, not all features of an actual implementation are described in the specification. It should be appreciated that, in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” “having,” and “based on” are intended to be inclusive and mean that there may be additional elements other than the listed elements.

As used herein, machine learning may refer to algorithms and statistical models that computing systems may use to perform a specific task with or without using explicit instructions. For example, a machine learning process may generate a mathematical model based on a sample of clean data, known as “training data,” in order to make predictions or decisions without being explicitly programmed to perform the task.

Users (e.g., guests) in an interactive environment (e.g., an immersive experience or an entertainment setting) may carry (e.g., hold and/or wear) objects (e.g., props; guest objects; interactive objects). The objects may be associated with a theme and/or may include any of a variety of handheld and/or wearable objects, such as a sword, wand, token, medallion, toy, ball, headgear, figurine, stuffed animal, clothing (e.g., hat), jewelry (e.g., necklace, bracelet, band), container, other portable object, or any combination thereof.

As described herein, the objects may be utilized to facilitate interactions with the interactive environment. For example, certain movements of an object may be detected as an input to initiate a special effect (e.g., special effect outputs; display of imagery, such as animated characters; lighting; sounds; and/or haptic effects). Such interactions in the interactive environment may generally involve detection or recognition of the object inside the interactive environment (e.g., with a sensor and/or via wireless communication), as well as control of the object and/or special effect features (e.g., components) of the interactive environment based on the detection or recognition of the object inside the interactive environment. In some cases, the control of the object and/or the special effect features of the interactive environment may be based on the detection or recognition of a pattern associated with the object (e.g., movement or operation of the object; gesture). Further, in some cases, the object may be associated with a user profile, such that aspects of the interactions may be linked to the user profile. The user profile may include various types of user profile information, such as accomplishments (e.g., achievements), including accomplishments due to actions performed by one or more users in the interactive environment and/or actions carried out using the object; user experience levels; past user locations; past object locations; past user experiences; user preferences, such as preferred characters and/or preferred colors; and/or user information, such as age and/or height. In an embodiment, the accomplishments may include a total of points awarded and saved to the user profile, such as due to the actions performed by the one or more users in the interactive environment and/or actions carried out using the object. In an embodiment, the special effects may be based on the user profile. It should be appreciated that the user profile may be associated with one or more users that utilize the object, for example.

Present embodiments relate generally to an interactive object control system associated with the interactive environment. The interactive object control system may include a controller (e.g., electronic controller; processing circuitry) that may receive various types of data, such as hyperspectral data (e.g., hyperspectral data cube), multi-band data (e.g., spectral band data), and/or image data (e.g., camera images or imagery; infrared (IR) camera images or imagery). The controller may process the data to identify an object and to track movement of the object within the interactive environment, and the controller may also initiate the special effects based on the object and/or the movement of the object within the interactive environment. In an embodiment, the controller may process the data (e.g., to identify light patterns in the data) to associate the object with a user profile. In an embodiment, the controller may be communicatively coupled to a radiofrequency identification (RFID) reader, such that the data may include an identifier of the object (e.g., read from a RFID tag of the object) to enable the controller to associate the object with the user profile (e.g., to access the user profile based on the identifier of the object). It should be appreciated that the controller may be communicatively coupled to another type of reader or communication circuitry that is capable of reading another type of readable code, such as an alphanumeric code, bar code, and/or quick response (QR) code, to enable the controller to associate the object with the user profile.

As described herein, the interactive object control system may include a hyperspectral imaging system. The hyperspectral imaging system may generate the hyperspectral data indicative of light emitted by an emitter of the object and/or light reflected by a reflector of the object. Further, the hyperspectral data may be indicative of a position of the emitter of the object and/or the reflector of the object in the interactive environment. For example, the hyperspectral data may be indicative of the position of the emitter of the object and/or the reflector of the object relative to the interactive environment.

The hyperspectral imaging system may include a hyperspectral camera, such as a snapshot hyperspectral camera, a pushbroom hyperspectral camera, a whisk broom hyperspectral camera, a band sequential scanner, a hyperspectral video camera, or a combination thereof. As such, the hyperspectral imaging system may collect hyperspectral data indicative of light (e.g., IR light) emitted by an emitter of the object and/or reflected by a reflector of the object at each pixel in a field of view of the hyperspectral camera, and the hyperspectral data indicative of the light emitted by the emitter of the object and/or reflected by the reflector of the object at each pixel in the field of view. The hyperspectral data may provide or include multiple images each representing the field of view in a particular range of the electromagnetic spectrum (e.g., spectral bands). Combining the multiple images may generate a hyperspectral data cube including three-dimensional data (e.g., x, y, λ), where x and y represent two spatial dimensions of the field of view, and λ represents a spectral dimension. Further, the hyperspectral data may use snapshot hyperspectral images and/or hyperspectral videos to indicate movement of the object in the interactive environment (e.g., the light emitted by the emitter of the object and/or reflected by the reflector of the object is tracked over time via the hyperspectral imaging system). As described in more detail herein, the hyperspectral imaging system may be utilized to efficiently identify the object and track the object in the interactive environment, even when multiple objects are present in the interactive environment.

In operation, multiple objects may be carried into the interactive environment. Presence of the multiple objects may be detected by the hyperspectral imaging system, wireless communication between the multiple objects and a communication device (e.g., the RFID reader) communicatively coupled to the controller, or any combination thereof. The controller may identify a best candidate object (e.g., a single object) among the multiple objects based on respective communication signals between the multiple objects and the communication device communicatively coupled to the controller. For example, the controller may identify the best candidate object among the multiple objects based on respective received signal strengths of the communication signals between the multiple objects and the communication device communicatively coupled to the controller (e.g., the best candidate object has a highest signal strength). In an embodiment, the communication signals may also provide respective object identification information for each of the multiple objects, which may be used by the controller to retrieve respective user profiles associated with each of the multiple objects.

In an embodiment, the controller may send operational instructions to the best candidate object (e.g., using the respective object identification information; targeted operational instructions based on and/or encoding the respective object identification information). The operational instructions may include instructions to activate an emitter on the best candidate object to cause the emitter to emit light (e.g., emitted light). The hyperspectral imaging system may detect the light (e.g., the emitted light), and thus, the best candidate object (e.g., confirm the best candidate object; tag the best candidate object for further tracking, such as in the field of view of the hyperspectral camera).

As described herein, the hyperspectral data may be indicative of the position of the best candidate object and/or movement of the best candidate object in the interactive environment. For example, the field of view of the hyperspectral camera may correspond to and/or be mapped to at least a portion of the interactive environment (e.g., a shared coordinate system). Thus, the controller may analyze the hyperspectral data to determine the position of the best candidate object. Further, the controller may analyze the hyperspectral data with reference to the position of the best candidate object to thereby track movement of the best candidate object. In particular, the controller may analyze the hyperspectral data that includes the light (e.g., the emitted light) to determine the position of the best candidate object (e.g., an initial position of the best candidate object). Then, the controller may analyze, with reference to the position of the best candidate object (e.g., the initial position of the best candidate object), the hyperspectral data to identify light (e.g., reflected light) that is likely due to reflection by a reflector of the best candidate object to thereby track the movement of the best candidate object over time. Advantageously, the hyperspectral imaging system may improve identification of the best candidate object relative to additional objects within the interactive environment. The hyperspectral imaging system may enable improved tracking of the best candidate object by using spectral signatures associated with the best candidate object to track the movement of the best candidate object within the interactive environment.

The interactive environment may be part of a venue, such as an entertainment venue (e.g., an amusement park, a theatre, a sports stadium), a retail establishment, a residential building, a school, and so forth. In an embodiment, the interactive environment may be a live show, where the users are in an audience and may be able to participate in the live show using the objects. In an embodiment, the interactive environment may be a walk-through attraction or a ride attraction, where users travel to experience different scenes and may be able to interact with the different scenes using the objects. Further, the interactive environment may include different locations that are geographically separated from one another or that are dispersed throughout the venue. The interactive environment may also be in a remote location. For example, each user may be able to establish the interactive environment at their home or any other location via an electronic device associated with the user (e.g., user electronic device; home console) that may interact with the object.

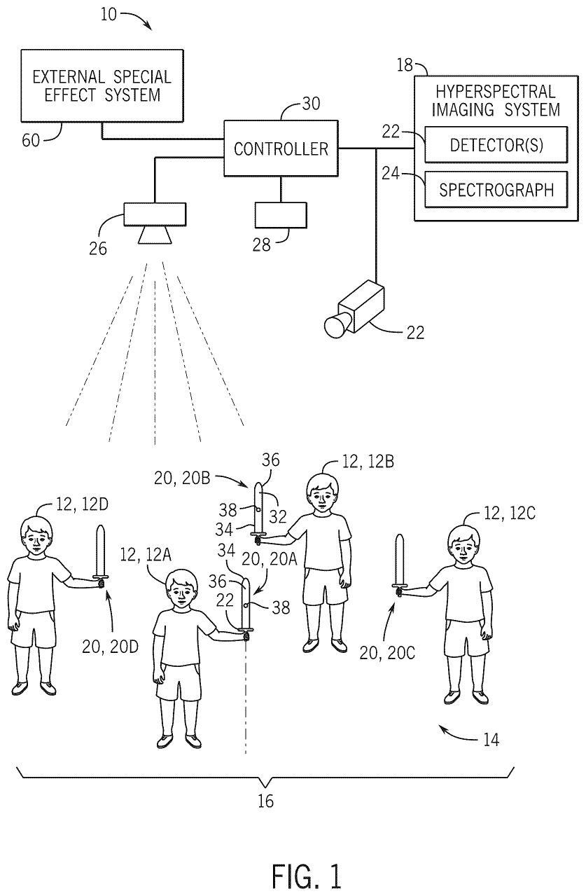

FIG. 1 is a schematic illustration of an embodiment of an interactive object system 10. In an embodiment, the interactive object system 10 may be associated with an interactive environment 14 and may be used to detect one or more interactive objects 20 in the interactive environment 14. The interactive environment 14 may include an area 16 (e.g., interactive area) proximate to (e.g., within a line-of-sight of) a hyperspectral imaging system 18. The hyperspectral imaging system 18 may include one or more detectors 22 (e.g., sensors, cameras, infrared (IR) cameras, short-wave infrared (SWIR) cameras, visible light cameras, capable of detecting any particular or suitable wavelength of light), a spectrograph 24, one or more additional components (e.g., slit(s), lens(es), mirror(s)), or a combination thereof). The interactive object system 10 may include one or more emitters 26 (e.g., IR light emitters, visible light emitters, capable of emitting any particular or suitable wavelength of light) and/or one or more communication devices 28 communicatively coupled to a controller 30.

In an embodiment, one or more users 12 may carry (e.g., hold and/or wear) the one or more interactive objects 20 in the interactive environment 14. For example, multiple users 12 and multiple interactive objects 20 may be present in the interactive environment 14, wherein each of the multiple users 12 carries a respective interactive object 20 (e.g., a first user 12A carries a first interactive object 20A, a second user 12B carries a second interactive object 20B, a third user 12C carries a third interactive object 20C, and a fourth user 12D carries a fourth interactive object 20D). Each of the one or more interactive objects 20 may include a housing 32 that supports various components, such as an object communication device 34 (e.g., communication circuitry; radio frequency identification (RFID) tag) that stores and transmits an identifier (e.g., unique identification code) to the one or more communication devices 28 (e.g., communication circuitry; a RFID reader). The housing 32 may also support an object emitter 36 and/or a detectable marker 38.

In operation with a single interactive object 20 in the area 16 (and thus, the single interactive object 20 is a best candidate interactive object in the area 16), the object communication device 34 may provide a unique identifier for the single interactive object 20 to the one or more communication devices 28. The one or more communication devices 28 may provide the unique identifier to the controller 30, and the controller 30 may retrieve or access a user profile associated with the unique identifier (e.g., from a database). The controller 30 may send an object-specific command based on the identifier and/or the user profile to cause the single interactive object 20 to emit light via the object emitter 36 (e.g., the object-specific command to the first interactive object 20A would cause the object emitter 36 of the first interactive object 20A to emit light, but would not cause the object emitter 36 of the second interactive object 20B to emit light). Then, if the hyperspectral imaging system 18 detects the light emitted by the object emitter 36 and generates hyperspectral data accordingly, then the controller 30 may utilize the hyperspectral data to determine (e.g., confirm) that the single interactive object 20 in the area 16 is properly identified and associated with the user profile.

Thus, any special effects provided in the interactive environment 14 during operation of the single interactive object 20 in the area 16 may account for details in the user profile. For example, the special effects may be based on user profile information, such as accomplishments (e.g., achievements), including accomplishments due to actions performed by one or more users in the interactive environment 14 and/or actions carried out using the single interactive object 20; user experience levels; past user locations; past object locations; past user experiences; user preferences, such as preferred characters and/or preferred colors; user information, such as age and/or height. In an embodiment, the accomplishments may include a total of points awarded and saved to the user profile, such as due to the actions performed by the one or more users in the interactive environment 14 and/or actions carried out using the single interactive object 20. For example, the special effects may include display of certain characters preferred by the user according to the user profile. Additionally, accomplishments (e.g., points) awarded due to actions within the interactive environment 14 may be saved to the user profile, and thus, the user profile may be updated over time.

As shown, the interactive object system 10 may include an external special effect system 60, which may provide special effects (e.g., one or more special effect outputs). The special effects may include displayed outputs, audio outputs, lighting outputs, flame effects, animated figures, and so forth. For example, the displayed outputs may include display of media, such as characters, scenery, and so forth. As another example, the animated figures may include actuatable characters and/or objects that include actuators to drive movement of the animated figures (or portions thereof) relative to the interactive environment 14.

Further, the hyperspectral data may indicate presence of and/or a position of the single interactive object 20 in the area 16. For example, the one or more detectors 22 of the hyperspectral imaging system 18 may determine (e.g., confirm) an identity of the single interactive object 20 based on a spectral signature (e.g., one or more features in the hyperspectral data; a spectral signature of the emitter for the single interactive object 20; a spectral signature of a reflector (for the single interactive object 20) of the light emitted and/or reflected by the single interactive object 20 in the area 16. For example, the spectral signature may include a series of distinct (e.g., unique) wavelengths in which the respective object emitter 36 may emit light. Additionally and/or alternatively, the spectral signature (e.g., spectral signature of the reflector for the single interactive object 20) may correspond to a series of distinct (e.g., unique) wavelengths corresponding to a retroreflector wavelength range in which the respective detectable marker 38 may reflect light. In this way, the interactive object system 10 may detect (e.g., confirm) presence of and/or the position of the single interactive object 20 based on the spectral signature associated with the light emitted by the respective object emitter 36 of the single interactive object 20, light reflected by the respective detectable marker 38 of the single interactive object 20, or both. Additionally, in operation with multiple interactive objects 20 in or near the area 16, the interactive object system 10 may detect (e.g., confirm) presence of the best candidate interactive object.

In an embodiment, each interactive object 20 may have or be associated with a respective unique spectral signature (e.g., detectable and/or identifying spectral signature; to identify each interactive object 20; to distinguish the interactive objects 20 from one another, other objects, and/or light sources). In an embodiment, a group of interactive objects 20 (e.g., team, type) may have or be associated with a respective unique spectral signature (e.g., detectable and/or identifying spectral signature; to identify each interactive objects 20 as part of a respective group; to distinguish groups from one another, other objects, and/or light sources). For example, a first set of interactive objects 20 (e.g., more than 1; 2, 3, 4, 5, 10, 100, 1000, or more) may be considered to be of a first team (e.g., type; associated with a first theme, associated with a first character, representative of a first object, having a first form (e.g., shape)), and each interactive object of the first set of interactive objects 20 may have (e.g., share) a first unique spectral signature. Similarly, a second set of interactive objects 20 (e.g., more than 1; 2, 3, 4, 5, 10, 100, 1000, or more) may be considered to be of a second team (e.g., type; associated with a second theme, associated with a second character, representative of a second object, having a second form (e.g., shape)), and each interactive object of the second set of interactive objects 20 may have (e.g., share) a second unique spectral signature. In an embodiment, all of the interactive objects 20 may have or be associated with a single unique spectral signature (e.g., detectable and/or identifying spectral signature; to distinguish the interactive objects 20 from other objects and/or light sources).

In an embodiment, the one or more object emitters 36 may emit light and/or the one or more detectable markers 38 may reflect light within the visible wavelength range, near-IR wavelength range, the SWIR wavelength range, IR wavelength range, or a combination thereof. The one or more object emitters 36 may emit light with a spectral signature to distinguish against sunlight, ambient lighting, and the like that may be present in the interactive environment 14. The one or more detectable markers 38 may include a retroreflector. As such, reflections (e.g., direct, diffuse, and/or passive) generated by the one or more detectable markers 38 may be used to track motion of the one or more interactive objects 20 within the interactive environment 14. In some instances, the one or more object emitters 36 may be used to initially identify the one or more interactive objects 20, such as to initially identify a best candidate interactive object of the one or more interactive objects 20. Further, in some instances, the one or more detectable markers 38 may be used to track motion of the one or more interactive objects 20, such as to track motion of the identified best candidate interactive object of the one or more interactive objects 20. Additionally or alternatively, it should be appreciated that the one or more object emitters 36 may be used to identify and track movement of at least one of the one or more interactive objects 20 (e.g., without use of the one or more detectable markers 38). Additionally or alternatively, it should be appreciated that the one or more detectable markers 38 may be used to identify and track movement of at least one of the one or more interactive objects 20 (e.g., without use of the one or more object emitters 36).

In an embodiment, the one or more object emitters 36 may be multi-frequency light emitters and may emit light over different and/or multiple ranges of wavelengths (e.g., IR wavelength ranges, SWIR wavelength ranges visible light wavelength ranges; 750 to 800 nanometers (nm), 900 to 1000 nm, 900 to 1700 nm, 1200 to 1800 nm). In an embodiment, the one or more detectable markers 38 may reflect light over different and/or multiple ranges of wavelengths (e.g., IR wavelength ranges, SWIR wavelength ranges, and/or visible light wavelength ranges; 750 to 800 nm, 900 to 1000 nm, 900 to 1700 nm, 1200 to 1800 nm). The one or more detectors 22 of the hyperspectral imaging system 18 may capture hyperspectral data corresponding to the spectral signature of the one or more object emitters 36 and/or the one or more detectable markers 38, and the hyperspectral data may facilitate detection and confirmation of the one or more interactive objects 20. For example, the hyperspectral data including spectral and spatial information associated with a field of view of an area in which the one or more interactive objects 20 may be used to detect and confirm presence of the best candidate interactive object of the one or more interactive objects 20. The hyperspectral data may be used to track motion of the detected best candidate interactive object in time and space. In this manner, the hyperspectral imaging system 18 may be used to confirm the best candidate interactive object is identified and enable tracking of the best candidate object within the area. In an embodiment, the hyperspectral imaging system 18 may continuously confirm that the best candidate object is being tracked within the hyperspectral data by verifying the spectral signature of a detected object against an expected spectral signature of the best candidate object.

The one or more detectors 22 may include one or more sensors. The one or more sensors may include an indium gallium arsenide (InGaAs) sensor, a mercury cadmium telluride (MCT) sensor, a charge coupled device (CCD) sensor, a complimentary metal-oxide-semiconductor (CMOS) sensor, or a combination thereof. The sensors may be selected based on the wavelength of light emitted by the one or more object emitters 36 and/or reflected by the one or more detectable markers 38. That is, a particular sensor may be selected to optimize collection of emitted light and/or reflected light to improve tracking of motions of the one or more interactive objects 20 within the interactive environment 14. For example, the sensor may include the InGaAs sensor capable of detecting SWIR wavelengths of light. As such, the InGaAs sensor may be used to capture hyperspectral data corresponding to the spectral signature of the one or more object emitters 36 in the SWIR region of the spectrum. In some embodiments, use of sensors in the SWIR region may be advantageous to improve detection of the interactive objects 20 through fog, rain, and/or smoke, in low light conditions, detect interactive objects 20 through materials such as glass, and/or differentiate interactive objects 20 from additional objects that may appear similar in visible light.

In an embodiment, the hyperspectral imaging system 18 may generate a hyperspectral data cube (e.g., hyperspectral data) including two dimensional spatial data and one dimensional spectral information within a field of view corresponding to at least a portion of the area 16. The hyperspectral data cube may be formed based on a type of image collection by the hyperspectral imaging system 18. For example, the hyperspectral imaging system 18 may include or utilize a snapshot type, a pushbroom type, a whiskbroom type, a band sequential scanner type, a vide type, or a combination thereof to acquire the hyperspectral data. In an embodiment, the hyperspectral data cube may be generated by using scanning types (e.g., the pushbroom type, the whiskbroom type, the sequential scanner type) or by non-scanning types (e.g., the snapshot type, the video type). The scanning type acquires the hyperspectral data cube by point scanning (e.g., the whiskbroom type), line scanning (e.g., the pushbroom type), and band scanning (e.g., the sequential scanner type). For example, the pushbroom type may build up the hyperspectral data cube by raster scanning across an area of interest. The non-scanning type acquires the hyperspectral data cube in a single shot. For example, the snapshot type may collect the hyperspectral data cube using a single integration time enabling faster acquisition times. The video type may provide hyperspectral data including spatial, spectral, and temporal dimensions. As such, the hyperspectral imaging system 18 may track movement of the one or more interactive objects 20 within the interactive environment 14 based using the video type of hyperspectral data acquisition. The hyperspectral imaging system 18 may identify and track multiple interactive objects simultaneously (e.g., even if trajectories of one or more interactive objects spatially overlap within the hyperspectral data cube). That is, trajectories of the multiple tracked interactive objects may be resolved in time to maintain active tracking of multiple interactive objects simultaneously.

The hyperspectral data cube may include a series of images corresponding to a field of view or an area of interest within the interactive environment 14. The hyperspectral data cube may provide one dimensional spectral data at a variety of wavelengths based on characteristics of the one or more detectors 22 and/or the spectrograph 24. The one or more detectors 22 of the hyperspectral imaging system 18 may build up the hyperspectral data cube (e.g. three-dimensional (3D) data cube) in one or more spectral regions. For example, the hyperspectral imaging system 18 may acquire spectral information optimized in wavelength ranges from 900 to 1650 nm, 900 to 2500 nm, 1000 to 2800 nm, 1100 to 1650 nm, 400 to 700 nm, 450 to 950 nm, 400 to 1000 nm, 900 to 1700 nm, and the like. In an embodiment, a respective center wavelength of the one or more detectors 22 and/or the spectrograph 24 may be selected to increase the spectral resolution within a wavelength range corresponding a known spectral signature(s) of the one or more object emitters 36 and/or the one or more detectable markers 38. For example, the known spectral signature of the one or more detectable markers 38 may correspond to 900 to 1700 nm. As such, the spectral resolution of the hyperspectral imaging system 18 may be selected for optimization of detection between 900 to 1700 nm to improve detection of the light reflected by the one or more detectable markers 38 to provide tracking of the one or more interactive objects 20 in the interactive environment 14. As such, in an embodiment the hyperspectral imaging system 18 may include an InGaAs sensor to optimize detection of the light reflected by the detectable markers 38 in the SWIR (e.g., about 900 to 1700 nm).

In an embodiment, the one or more emitters 26 may be used during tracking of movement of the interactive objects 20. The one or more emitters 26 may emit light within any suitable range of wavelengths (e.g., IR wavelength range, SWIR wavelength range, and/or visible light wavelength range) that corresponds to a retroreflector wavelength range of the one or more detectable markers 38 of the one or more interactive objects 20, such as including the respective detectable marker 38 of the best candidate interactive object of the one or more interactive objects 20. For example, the wavelength range may include wavelengths of approximately 800 to 1100 nm, 900 to 1650 nm, 900 to 2500 nm, 1000 to 2800 nm, 1100 to 1650 nm, 400 to 700 nm, 450 to 950 nm, 400 to 1000 nm, 900 to 1700 nm, and the like. In an embodiment, the one or more emitters 26 may be multi-frequency light emitters and may emit light over different and/or multiple wavelength ranges (e.g., IR wavelength ranges, SWIR wavelength ranges, and/or visible light wavelength ranges; 800 to 850 nm, 900 to 1100 nm, 900 to 1700 nm), which may facilitate separate detection and tracking of multiple interactive objects 20. In an embodiment, the one or more emitters 26 and the one or more object emitters 36 may emit light over different wavelength ranges (e.g., 800 to 850 nm, 960 to 1100 nm, and/or 900 to 1700 nm for the one or more emitters 26, and 750 to 790 nm and/or 900 to 950 nm for the object emitters 25) to facilitate differentiation of various light emissions and/or corresponding light reflections. In cases where the one or more emitters 26 and the one or more object emitters 36 emit light in overlapping wavelength ranges, the controller 30 may provide instructions to emit the light from the one or more emitters 26 and the light from the one or more object emitters 36 at different times (e.g., turn off the one or more emitters 26 temporarily (e.g., turn off for one or more milliseconds) to enable detection of the light emitted by the one or more object emitters 36).

In the example with the single interactive object 20, the one or more detectors 22 of the hyperspectral imaging system 18 may generate hyperspectral data indicative of the light reflected by the respective detectable marker 38 of the single interactive object 20. Further, the hyperspectral data may be indicative of movement of the single interactive object 20 in the interactive environment 14 (e.g., the light reflected by the respective detectable marker 38 of the single interactive object 20 is tracked over time via the one or more detectors 22). For example, the hyperspectral data may indicate that the single interactive object 20 moved in a swirl pattern, a swipe motion, an up and down motion, and so forth. Because the controller 30 received the unique identification code and the hyperspectral data indicative of the position of the single interactive object 20 in the interactive environment 14, the controller 30 may efficiently and reliably (e.g., with a high level of confidence, as compared to systems that track without features disclosed herein) track the single interactive object 20 in the interactive environment 14, identify successful or complete movements (e.g., gestures) performed with the single interactive object 20, assign achievements to the user profile and/or otherwise update the user profile, provide personalized special effects based on the user profile, and so forth.

Importantly, the interactive object system 10 may enable the controller 30 to track a particular interactive object 20 (e.g., the best candidate interactive object, which may be the single interactive object 20) even with additional interactive objects 20 in the area 16 (e.g., within the field of view of the one or more detectors 22). For example, in operation with the single interactive object 20 in the area 16, even if the additional interactive objects 20 enter the area 16 and reflect light toward the one or more detectors 22, the controller 30 will continue to identify and separately track the reflections (e.g., a trail of reflections during motion) from the single interactive object 20 since the single interactive object 20 has been initially identified via the respective object emitter 36 and/or the respective detectable marker 38. For example, the single interactive object 20 may be tagged in the hyperspectral data by tracking a reflection as being associated with (e.g., caused by; originating at) the single interactive object 20, such that ongoing or future reflections (e.g., trail; consecutive reflections) may be appropriately and accurately linked to (e.g., attributed to) the single interactive object 20. In an embodiment, the hyperspectral imaging system 18 may perform simultaneous tracking of multiple interactive objects by performing localization of each independent interactive object 20 in a first hyperspectral data cube. Localization may be based on spatially defining a path (e.g., a trajectory) of each independent interactive object 20 by extracting positions of each interactive object from hyperspectral data (e.g., a series of time-lapsed hyperspectral data cubes). An identify of each independent interactive object 20 may be established by labeling the path of each independent interactive object 20 based on a spectral signature of the emitter and/or reflector captured by in the hyperspectral data. Such localization and labeling may be achieved using tracking algorithms used to build trajectories of multiple objects in space and time. The spectral information offered by the hyperspectral data may be used to continuously confirm labels associated with the spectral signatures of each independent interactive object 20. In this manner, the hyperspectral imaging system 18 may identify and track multiple interactive objects within hyperspectral data captured by the one or more detectors 22.

Further, the interactive object system 10 may enable the controller 30 to also track one or more of the additional interactive objects 20 in the area 16 (e.g., within the field of view of the one or more detectors 22; simultaneously and/or sequentially track multiple interactive objects 20). For example, if multiple interactive objects 20 are in the area 16, the one or more communication devices 28 may communicate with each of the multiple interactive objects 20 (e.g., any of the object communication devices 34 of the multiple interactive objects 20 within communication range). Thus, the controller 30 may obtain, via the one or more communication devices 28, respective unique identifiers for each of the multiple interactive objects 20. The controller 30 may use the respective unique identifiers to retrieve or access respective user profiles. The controller 30 may select or designate the best candidate interactive object (e.g., the first interactive object 20A or the second interactive object 20B) of the multiple interactive objects 20, such as based on a signal strength of respective communications signals between the multiple interactive objects 20 and the one or more communication devices 28 (e.g., to select a highest strength signal, indicative of proximity to a desirable location to carry out interactions) and/or based on aspects of the respective user profiles (e.g., to select a user profile with particular user profile information, such as particular achievements).

In an embodiment, the controller 30 may send the object-specific command based on the user profile associated with the best candidate interactive object to cause the best candidate interactive object to emit light via the respective object emitter 36. Then, if the one or more detectors 22 of the hyperspectral imaging system 18 detect the light emitted by the respective object emitter 36 and generate hyperspectral data accordingly, then the controller 30 may utilize the hyperspectral data to determine (e.g., confirm) that the best candidate interactive object in the interactive environment 14 is appropriately identified and associated with the user profile. For example, light emitted based on the best candidate interactive object satisfying the object-specific command may be captured in the hyperspectral data as a unique spectral signature and/or a pattern of detected light (e.g., spatial data and/or spectral data). The hyperspectral imaging system 18 may compare the hyperspectral data to expected data indicative of the object-specific command such as a predefined spectral signature and/or a predefined pattern of detected light. Thus, any special effects provided in the interactive environment 14 during operation of the best candidate interactive object in the interactive environment 14 may account for details in the user profile, such as accomplishments awarded due to actions within the interactive environment 14 and/or other user profile information disclosed herein. It should be noted that if the one or more detectors 22 do not detect expected light emissions (e.g., the light expected to be emitted by the respective object emitter 36) and generate the hyperspectral data accordingly, the controller 30 may utilize the hyperspectral data to determine that the best candidate interactive object in the interactive environment 14 may not be appropriately identified and may not be properly associated with the user profile.

Further, if the hyperspectral imaging system 18 detects the light emitted by the respective object emitter 36, the hyperspectral data may indicate a position of the best candidate interactive object in the interactive environment 14. For example, the position may include the approximate position or coordinates in the area 16. Additionally, the one or more emitters 26 may emit light within any suitable wavelength range to cause reflection from the one or more detectable markers 38 of the one or more interactive objects 20, such as at least from the respective detectable marker 38 of the best candidate interactive object. The hyperspectral imaging system 18 may generate hyperspectral data indicative of the light reflected by the one or more detectable markers 38 of the one or more interactive objects 20, including at least from the respective detectable marker 38 of the best candidate interactive object. Further, the hyperspectral data may be indicative of movement of the one or more interactive objects 20, including at least respective movement of the best candidate interactive object. Because the controller 30 received the unique identification code and the hyperspectral data, one or both of which may be indicative of an identity of the best candidate interactive object (e.g., and the user profile) and/or indicative of the position of the best candidate interactive object in the interactive environment 14, the controller 30 may efficiently and reliably track the best candidate interactive object (e.g., tagged in the image data based on the position derived from the hyperspectral data), identify successful or complete movements performed with the best candidate interactive object, assign accomplishments to the user profile and/or otherwise update the user profile information in the user profile, provide personalized special effects based on the user profile, and so forth.

It should be appreciated that the interactive object system 10 may enable the controller 30 to sequentially identify and designate best candidate interactive objects to thereby track multiple interactive objects 20 in the area 16 (e.g., within the field of view and/or the area of interest of the one or more detectors 22). For example, based on the unique identifier of the first interactive object 20A, the controller 30 may provide the object-specific command to cause the first interactive object 20A to emit light via the respective object emitter 36 of the first interactive object 20A. Then, upon detection of the light by the one or more hyperspectral imaging system 18, the controller 30 may utilize the hyperspectral data to determine the position of the first interactive object 20A in the interactive environment 14. Additionally, with information about the position of the first interactive object 20A, the controller 30 may tag the first interactive object 20A in the hyperspectral data to track motion of the first interactive object 20A in the interactive environment 14. As noted herein, the controller 30 may track the motion based on the hyperspectral data that indicates the light reflected by the respective detectable marker 38 of the first interactive object 20A.

After providing the object-specific command to cause the first interactive object 20A to emit light via the respective object emitter 36 of the first interactive object 20A and based on the unique identifier of the second interactive object 20B, the controller 30 may provide the object-specific command to cause the second interactive object 20B to emit light via the respective object emitter 36 of the second interactive object 20B. Then, upon detection of the light by the hyperspectral imaging system 18, the controller 30 may utilize the hyperspectral data to determine the position of the second interactive object 20B in the interactive environment 14. Additionally, with information about the position of the second interactive object 20B, the controller 30 may tag the second interactive object 20B in the hyperspectral data to track motion of the second interactive object 20B in the interactive environment 14. As noted herein, the controller 30 may track the motion based on the hyperspectral data that indicates the light reflected by the respective detectable marker 38 of the second interactive object 20B. The interactive object system 10 may carry out these steps to identify and track additional interactive objects 20. For example, the interactive object system 10 may simultaneously track the first interactive object 20A and the second interactive object 20B.

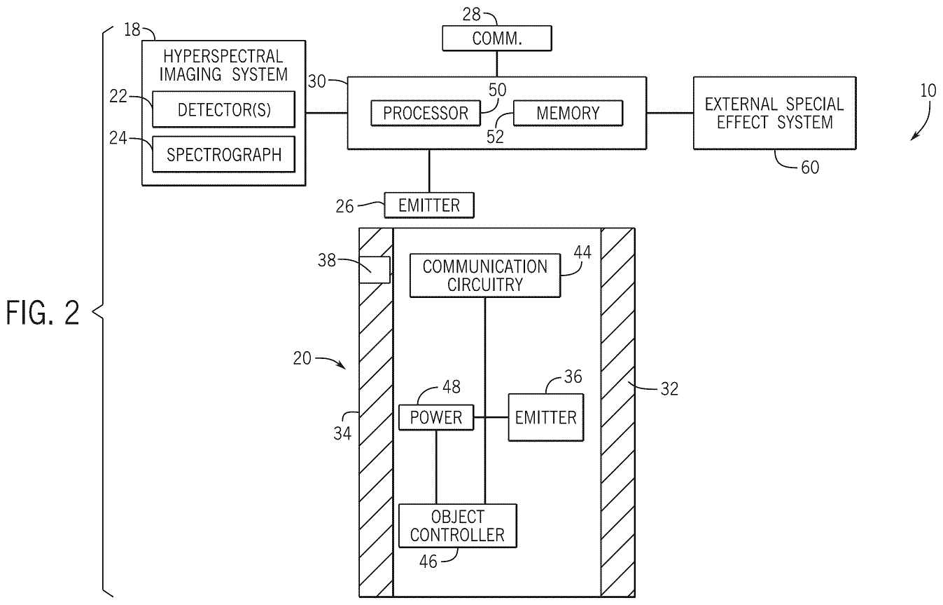

FIG. 2 is a schematic diagram of an embodiment of the interactive object system 10 demonstrating communication between the one or more interactive objects 20 and various components of the interactive object system 10 external to the one or more interactive objects 20. Disclosed techniques for tracking the one or more interactive objects 20 may utilize the hyperspectral imaging system 18.

As shown, the respective object communication device 34 may include communication circuitry 44, an object controller 46, a power source 48, the object emitter 36, one or more additional components, or a combination thereof. As described herein, in operation with a single interactive object 20, the respective object communication device 34 may provide a unique identifier for the single interactive object 20 to the one or more communication devices 28. A housing 32 may support the object communication device 34 (e.g., communication circuitry; radio frequency identification (RFID) tag), an object emitter 36 and/or a detectable marker 38. The one or more communication devices 28 may provide the unique identifier to the controller 30, and the controller 30 may retrieve or access a user profile associated with the unique identifier. The controller 30 may send the object-specific command based on the user profile to cause the single interactive object 20 to emit light via the respective object emitter 36. Then, if the one or more detectors 22 and/or the spectrograph 24 of the hyperspectral imaging system 18 detect the light emitted by the respective object emitter 36 and generate hyperspectral data accordingly, then the controller 30 may utilize the hyperspectral data to determine that the single interactive object 20 in the interactive environment 14 as shown in FIG. 1 is appropriately identified and associated with the user profile. In an embodiment, the hyperspectral data (e.g., unique to the single interactive object 20) may confirm both that single interactive object 20 is appropriately identified (e.g., the hyperspectral data corresponds to a spectral signature known and/or stored for the single interactive object 20, such as in the user profile, or in a device profile within or associated with the user profile) and also may confirm a position of the single interactive object 20 in the interactive environment 14. Thus, special effects (e.g., special effect outputs) provided via an external special effect system 60 may account for details in the user profile. For example, the special effects may be based on user profile information, such as accomplishments (e.g., achievements), including accomplishments due to actions performed by one or more users in the interactive environment 14 and/or actions carried out using the single interactive object 20; user experience levels; past user locations; past object locations; past user experiences; user preferences, such as preferred characters and/or preferred colors; user information, such as age and/or height. In an embodiment, the accomplishments may include a total of points awarded and saved to the user profile, such as due to the actions performed by the one or more users in the interactive environment 14 and/or actions carried out using the single interactive object 20. For example, the special effects may include display of certain characters preferred by the user according to the user profile and/or display of favorite color according to the user profile. Additionally, accomplishments (e.g., points) awarded due to actions within the interactive environment 14 may be saved to the user profile, and thus, the user profile may be updated over time. Further, as noted herein, the hyperspectral data may indicate the position of the single interactive object 20 in the interactive environment 14.

Additionally, the controller 30 may instruct the one or more emitters 26 to emit light within any suitable wavelength range that corresponds to a retroreflector wavelength range of the one or more detectable markers 38 of the one or more interactive objects 20, including the respective detectable marker 38 of the single interactive object 20. In the example with the single interactive object 20, the one or more detectors 22 may generate image data indicative of the light reflected by the respective detectable marker 38 of the single interactive object 20. Further, the image data may be indicative of movement of the single interactive object 20 in the interactive environment 14 (e.g., the light reflected by the respective detectable marker 38 of the single interactive object 20 is tracked over time via the one or more detectors 22). For example, the hyperspectral data may indicate that the single interactive object 20 moved in a swirl pattern, a swipe motion, an up and down motion, and so forth. Because the controller 30 received the unique identification code and the hyperspectral data indicative of the position of the single interactive object 20 in the interactive environment 14, the controller 30 may efficiently and reliably track the single interactive object 20 in the interactive environment 14, identify successful or complete movements performed with the single interactive object 20, assign accomplishments to the user profile and/or otherwise update the user profile, provide personalized special effects (e.g., special effect outputs) via the external special effect system 60 based on the user profile, and so forth.

Importantly, the interactive object system 10 may enable the controller 30 to track the single interactive object 20 even when proximate to additional interactive objects 20 (e.g., within the field of view and/or the area of interest of the one or more detectors 22). For example, even if the additional interactive objects 20 reflect the light toward the one or more detectors 22, the controller 30 will continue to identify and separately track the reflections (e.g., a trail of reflections during motion) from the single interactive object 20 since the single interactive object 20 has been initially tagged in the image data based on the position derived from the hyperspectral data.

As shown, the respective object controller 46 may control other components of the single interactive object 20. For example, the respective object controller 46 may control the respective object emitter 36, which may be powered either passively (e.g., via power harvesting) or actively (e.g., by the respective power source 48). In the depicted embodiment, the respective object communication device 34 may emit a wireless signal that communicates object identification information via a RFID tag, an infrared light signal, or the like.

It should be appreciated that the controller 30 may include one or more processors 50 and one or more memory devices 52. The one or more processors 50 may include one or more application specific integrated circuits (ASICs), one or more field programmable gate arrays (FPGAs), one or more general purpose processors, or any combination thereof. Additionally, the one or more memory devices 52 may include volatile memory, such as random access memory (RAM), and/or non-volatile memory, such as read-only memory (ROM), optical drives, hard disc drives, or solid-state drives. The controller 30 may include one or more controllers (e.g., in the interactive environment 14) that communicate with each other through the use of a wireless mesh network (WMN) or other wireless and/or wired communication methods.

The controller 30 may be part of a distributed decentralized network of one or more controllers. The decentralized network of the one or more controllers may facilitate reduction in processing time and processing power required for the one or more controllers dispersed throughout one or more interactive environments 14. The decentralized network of the one or more controllers may be configured to obtain user profiles by requesting the user profiles from a profile feed stored in a central server. The user profile feed may include user accomplishments and/or other user profile information disclosed herein. The one or more controllers may act as edge controllers that subscribe to a profile feed including multiple user profiles stored in the central server and cache the profile feed to receive one or more user profiles contained in the profile feed.

As described herein, additional controller(s) and/or processor(s) may be associated with (e.g., located on; housed within) the hyperspectral imaging system 18, the one or more emitters 26, and/or other components. The additional controller(s) and/or processor(s) may facilitate edge processing to reduce latency, reduce power usage, and so forth. Together, the controller 30 (e.g., which may include one or more controllers), the processor 50 (e.g., which may include one or more processors), the memory device 52 (e.g., which may include one or more memory devices), the network of one or more controllers in the decentralized network, and/or the respective object controllers 46 on the one or more interactive objects 20 may carry out processing operations to carry out the techniques disclosed herein. It should be appreciated that “processing circuitry” and/or “control circuitry” as used herein may refer to any combination of these control and/or processing components, and the processing operations may be distributed in any suitable manner (e.g., one or more operations carried out by one processor of the processing circuitry, one or more other operations carried out by another processor of the processing circuitry, and so forth).

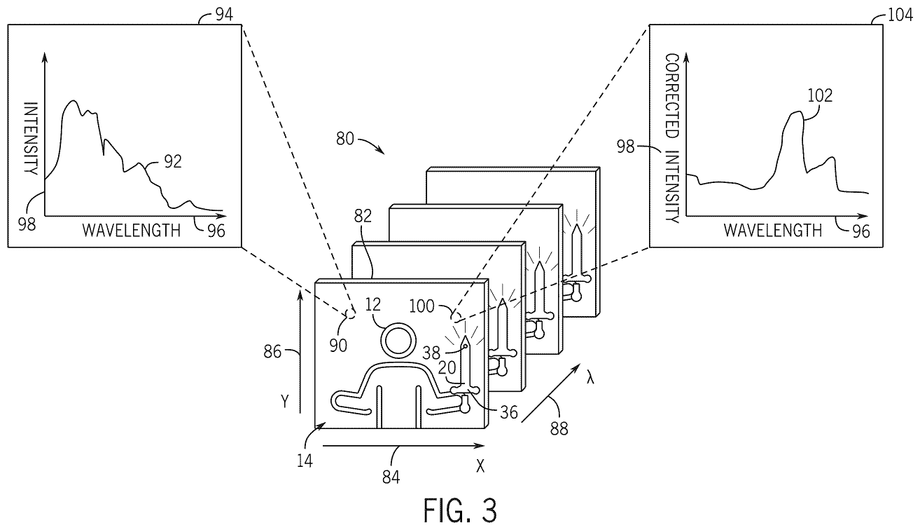

FIG. 3 is a schematic illustration of an example of hyperspectral data from the hyperspectral imaging system. As shown, the hyperspectral data includes a hyperspectral data cube 80. The hyperspectral data cube 80 may include three-dimensional (3D) information and/or four-dimensional (4D) information of an area of interest 82 of a portion of the interactive environment 14. For example, the hyperspectral data cube 80 may represent two dimensional (2D) spatial information represented by an x-axis 84 and a y-axis 86, one dimensional (1D) spectral information represented by a λ-axis 88, and/or 1D temporal information (not shown). As shown in FIG. 3, the area of interest 82 may include hyperspectral data based on a position of the respective object emitter 36 and/or the respective detectable marker 38 of a particular interactive object 20 (e.g., the best candidate interactive object, which may be the single interactive object 20) held by a particular user 12. The area of interest 82 may correspond to a location of a special effect object (not shown; e.g., animated figure, display, light emitter, speaker, haptic device, and so forth) associated with providing a special effect upon activation of the special effect object by the particular interactive object 20 (e.g., special effect outputs; movement of the animated figure, such as move the animated figure relative to a ground surface and/or to move one part of the animated figure relative to another part of the animated figure; display of imagery, such as virtual animated characters on the display; lighting from the light emitter; sounds from the speaker; and/or haptic effects from the haptic device).

In an embodiment, the hyperspectral data 18 generates three-dimensional (3D) spectral information including the spatial information (e.g., x-axis 84 and y-axis 86) indicative of the position of the particular interactive object 20 within the area of interest 82. The position of the particular interactive object 20 may be determined by analyzing the hyperspectral data 18 to account for environmental noise and/or perform object detection based on optical characteristics of the respective object emitter 36 and/or the respective detectable marker 38 of the particular interactive object 20. It should be noted, in an embodiment, machine learning techniques, such as artificial intelligence algorithms may be utilized to determine positions of the particular interactive object 20, environmental noise, background corrections, and the like. For example, an AI tracking algorithm (e.g., recurrent neural networks (RNNs), autoencoders (AEs), generative adversarial networks (SNNs), etc.) may be used to determine the position of the particular interactive object 20 within the area of interest 82 tracking one or more coordinates within the hyperspectral data cube 80 based on an intensity of a signal, a spectral signature of the particular interactive object 20, one or more additional features of the hyperspectral data, or a combination thereof.

In an embodiment, a tracking algorithm may be based on a series of rules based on one or more thresholds. For example, an intensity threshold may be determined based on a proximity of the particular interactive object 20 to the one or more detectors 22 of the hyperspectral imaging system 18 shown in FIG. 1. Additionally and/or alternatively the series of rules may be based on a spectral signature of the of the particular interactive object 20. For example, the respective object emitter 36 and/or the respective detectable marker 38 may be associated with a spectral response within a spectral window. As such, the tracking algorithm may identify the spectral response within the spectral signature and assign the position of the particular interactive object 20 within the area of interest 82. In an embodiment, multiple coordinates may be close to the respective thresholds and/or the spectral signature. The tracking algorithm may use identification information such as an expected spectral signature of an emitter, an expected spectral signature of a reflector, or a combination thereof of to identify the particular interactive object 20 as the best candidate interactive object to track using the hyperspectral data.

In an embodiment, the hyperspectral data cube 80 may be analyzed by performing background correction to reduce impacts from environmental noise on tracking of the particular interactive object 20 within the area of interest 82. For example, a portion of the area of interest may be used as a background area 90. The background area 90 may correspond to one or more coordinates of the hyperspectral data cube 80 in which the particular interactive object 20 is not located. The background area 90 may include a single coordinate and/or an average of coordinates within the area of interest 82. A background spectrum 92 of the background area 90 is illustrated in a background graph 94 including a spectral axis 96 and an intensity axis 98. The background spectrum 92 of the hyperspectral data cube 80 may provide spectral information of the background across a spectral window (e.g., visible wavelengths, near-IR wavelengths, SWIR, IR wavelengths, or a combination thereof). For example, the background spectrum 92 may include signal from one or more sources of environmental noise, such as solar radiation, ambient lighting, one or more devices (e.g., phone, wireless communication devices, etc.), or a combination thereof.

In an embodiment, background correction may be applied based on the background spectrum 92 across the area of interest 82 for the hyperspectral data collected by the hyperspectral imaging system 18. In some instances, background correction may be performed during acquisition of the hyperspectral data (e.g., real-time). Additionally and/or alternatively, background correction may be performed after acquisition of the hyperspectral data (e.g., the hyperspectral data cube 80). Background correction may reduce impacts from environmental noise, one or more additional sources of noise, and the like. It should be noted, that coordinates of the background area 90 and/or an object area 100 may change as a function of time. For example, one or more additional hyperspectral cubes may be acquired for the area of interest 82 in sequence as the particular user 12 moves the particular interactive object 20 from a first position to a second position and the like.

In an embodiment, the object area 100 of the area of interest 82 within the hyperspectral data cube 80 may be identified by the tracking algorithm. For example, a portion of the area of interest may correspond to the object area 100 corresponding to the position of the particular interactive object 20, reflections of the respective detectable marker 38, light emitted by the respective object emitter 36, or a combination thereof. The object area 100 may correspond to one or more coordinates of the hyperspectral data cube 80 in which the particular interactive object 20 is located. The object area 100 may include a single coordinate and/or an average of coordinates within the area of interest 82. An object spectrum 102 of the object area 100 is illustrated in an object graph 104 including the spectral axis 96 and the intensity axis 98. The object spectrum 102 of the hyperspectral data cube 80 may provide spectral information of the particular interactive object 20 across a spectral window (e.g., visible wavelengths, near-IR wavelengths, SWIR, IR wavelengths, or a combination thereof). For example, the object spectrum 102 may include a signal indicative of the spectral signature of the particular interactive object 20. It should be noted, in an embodiment, the object spectrum 102 may be background corrected based on the background spectrum 92. The spectral signature of the particular interactive object 20 may include a signal at one or more areas of the spectral window. The spectral signature of the particular interactive object 20 may be determined using machine learning methods. In an embodiment, the particular interactive object 20 may have or be associated with a respective unique spectral signature. In an embodiment, a group of interactive objects 20 (e.g., team, type) may have or be associated with a respective unique spectral signature. For example, a first subset of the interactive objects 20 (e.g., a first group of multiple interactive objects) may be associated with a first spectral signature indicative of a first type of interactive object, a second subset of the interactive objects 20 (e.g., a second group of multiple interactive objects) may be associated with a second spectral signature indicative of a second type of interactive object, and so forth. In an embodiment, all of the interactive objects 20 may have or be associated with a single unique spectral signature (e.g., to distinguish the interactive objects 20 from other objects and/or light sources). As such, detection of the particular spectral signature may result in activation of one or more respective special effects.

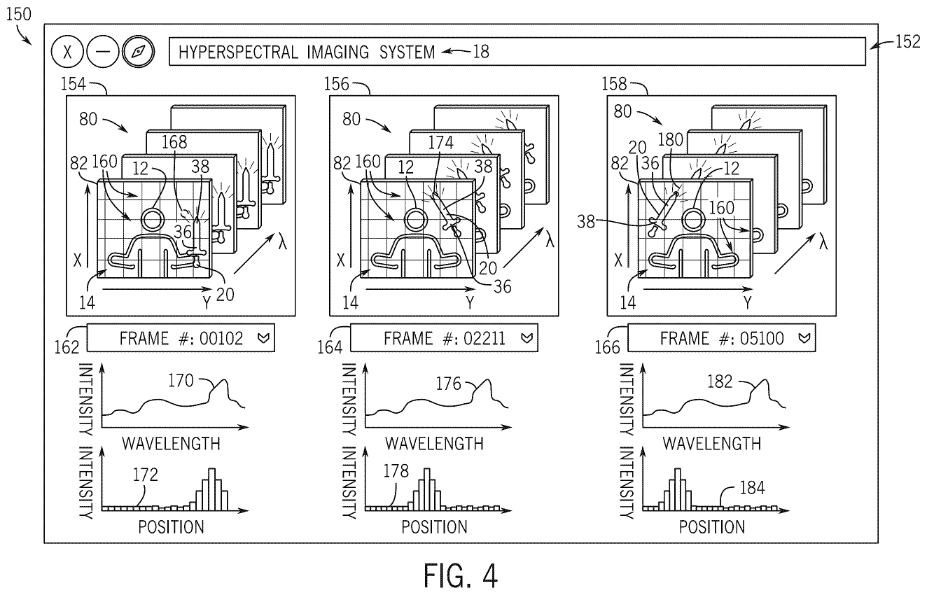

FIG. 4 is schematic embodiment of an example of a user interface 150 (e.g., graphical user interface (GUI)) of the hyperspectral imaging system 18. The user interface 150 may display a screen having a dashboard 152 (e.g., command center) that may be used to analyze hyperspectral data generated by the hyperspectral imaging system 18. In this manner, the interactive object system 10 may provide centralized feedback to one or more operational users of the dashboard 152. The dashboard 152 may include various widgets (e.g., user interface widgets) providing alerts, notifications, data analysis, interactive object detection, and the like.

In an embodiment, the hyperspectral imaging system 18 may acquire hyperspectral data as a function of time. Temporal information may be acquired as a series of hyperspectral data cubes 80 of the area of interest 82 to acquire positional data and track motion of a particular interactive object 20 used by a particular user 12 in the interactive environment 14. The series of hyperspectral data cubes 80 may be acquired using a snapshot hyperspectral imaging detector, video hyperspectral imager, and the like. Acquisition of temporal information may provide tracking of the particular interactive object 20 as the particular user 12 interacts with one or more interactive objects (not shown; e.g., animated character, display, speaker, haptic device, and so forth) within the interactive environment 14. Analysis of the series of hyperspectral data cubes 80 may trigger one or more special effects as a result of detection of motion (e.g., target motion; desired motion) of the particular interactive object 20.

In an embodiment, the series of hyperspectral data cubes 80 collected by the hyperspectral imaging system 18 may be used to identify a position of the particular interactive object 20 in the area of interest 82 and/or movement of the particular interactive object 20 temporally in the area of interest 82. As shown, the series of hyperspectral data cubes 80 may include a first hyperspectral data cube 154, a second hyperspectral data cube 156, a third hyperspectral data cube 158, one or more additional hyperspectral data cubes, and the like. In an embodiment, acquisition of the hyperspectral data may use compressive sensing techniques to improve throughput of data to reduce data transmission and storage requirements. Compressive sensing techniques may improve data acquisition of high dimensionality hyperspectral data (e.g., the series of hyperspectral data cubes 80) by collecting sparse data in at least one dimension (e.g., spatial, spectral, temporal) of the hyperspectral data. For example, compressive sensing techniques may be used to reduce data acquisition requirements within the area of interest 82 and provide post-data acquisition reconstruction to improve processing times and reduce latency of the hyperspectral imaging system 18. It should be noted, that compressive sensing is one non-limiting example and one or more additional data acquisition techniques may be applied to improve acquisition speeds, reduce data size, and the like of the hyperspectral imaging system 18.

In certain embodiments, the series of hyperspectral data cubes 80 may be associated with a grid 160 (e.g., a coordinate system, virtual grid, 4×4 grid, 8×8 grid, 16×16 grid, 32×32 grid) mapped to the area of interest 82 of the interactive environment 14 (e.g., real-world environment), and the hyperspectral data may be used to determine a position of the particular interactive object 20 relative to the grid 160. For example, the hyperspectral data may be indicative of the position of the particular interactive object 20 relative to the grid 160, such as an approximate position or coordinates, such as an X (row) and Y (column) coordinate within the grid 160. As shown, the first hyperspectral data cube 154 is representative of hyperspectral data corresponding to a first frame 162 of the hyperspectral data, the second hyperspectral data cube 156 is representative of hyperspectral data corresponding to a second frame 164 of the hyperspectral data, and the third hyperspectral data cube 158 is representative of hyperspectral data corresponding to a third frame 166 of the hyperspectral data. It should be noted, the first, second, and/or third frame 162, 164, 166 of the hyperspectral data may correspond to any frame of hyperspectral data (e.g., the series of hyperspectral data cubes 80).

In an embodiment, the particular interactive object 20 may be tracked over the series of hyperspectral data cubes 80. For example, a first position 168 of the particular interactive object 20 relative to the grid 160 may be identified. The hyperspectral data may be analyzed to extract a first spectrum 170 of the first position 168 and/or a localization measurement 172 of the particular interactive object 20 in the first hyperspectral data cube 154. A second position 174 of the particular interactive object 20 relative to the grid 160 may be identified. The hyperspectral data may be analyzed to extract a second spectrum 176 of the second position 174 and/or a localization measurement 178 of the particular interactive object 20 in the second hyperspectral data cube 156. A third position 180 of the particular interactive object 20 relative to the grid 160 may be identified. The hyperspectral data may be analyzed to extract a third spectrum 182 of the third position 180 and/or a localization measurement 184 of the particular interactive object 20 in the third hyperspectral data cube 158. The spectral information provided by the first, second, and/or third spectrum 170, 176, 182 may be used to identify a spectral signature of a respective detectable marker 38 of the particular interactive object 20. The positional information provided by the first, second, and/or third localization measurement 172, 178, 184 may be used to identify a position of the respective detectable marker 38 of the particular interactive object 20 temporally. In this manner, the localization measurements may be used to track motion of the particular interactive object 20 within the area of interest 82 in the interactive environment 14. In some instances, one or more particular tracked motions of the particular interactive object 20 may trigger one or more special effects via the one or more interactive devices residing in (e.g., fixed in, permanently in, not carried by the particular user 12 or other users) the interactive environment 14, award one or more points due to the actions performed by the particular user 12 in the interactive environment 14 and/or actions carried out for one or more additional users of the particular interactive object 20, and/or result in feedback on the particular interactive object 20. In an embodiment, the special effects, award, and/or feedback may be triggered based on the user profile.

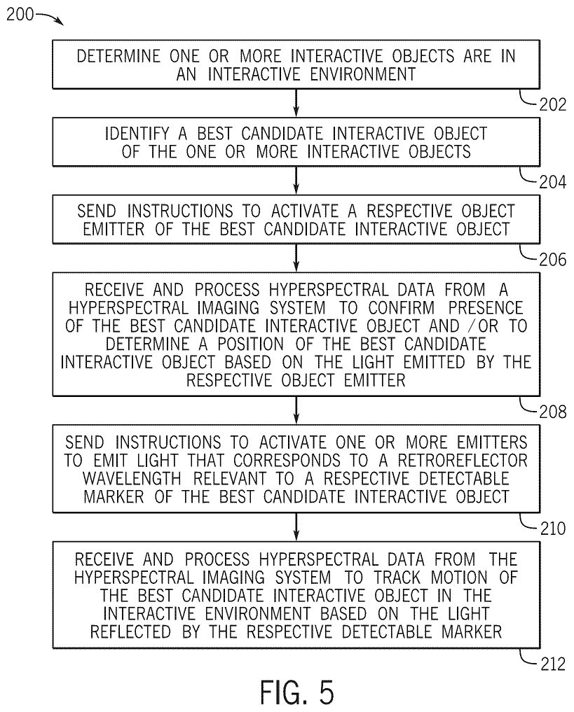

FIG. 5 is a flow diagram of an embodiment of a process 200 for detecting an interactive object. The process 200 may be performed by any suitable processing system, such as the controller 30 and/or the hyperspectral imaging system 18 disclosed above with reference to FIG. 1 and FIG. 2. Furthermore, the blocks of the process 200 may be performed in the order disclosed herein or in any suitable order. For example, certain blocks of the process 200 may be performed concurrently. In addition, in certain embodiments, at least one additional block may be added to the process 200 and/or at least one of the blocks of the process 200 may be omitted.

At block 202 of the process 200, the processing system may determine one or more interactive objects are in an interactive environment (e.g., identify, detect, and/or determine presence of the one or more interactive objects in the interactive environment). This may be based on communication between communication circuitry (e.g., RFID tag) of the one or more interactive objects and communication circuitry (e.g., RFID reader) communicatively coupled to a controller. In an embodiment, this may be based on detection of light (e.g., IR light; emitted and/or reflected by the one or more interactive objects) by a detection system, such as at a hyperspectral imaging system, at one or more additional one or more cameras (e.g., IR cameras), and the like.

At block 204 of the process 200, the processing system may identify a best candidate interactive object of the one or more interactive objects. In an embodiment, this may be based on respective signal strengths of the RF signals received from the one or more interactive objects at the communication circuitry. In an embodiment, this may be based on factors in the respective user profiles associated with the one or more interactive objects, wherein the respective user profiles may be accessed using respective unique identifiers encoded in the RF signals received from the one or more interactive objects at the communication circuitry, patterns in the light, spectral signatures associated with the best candidate object, any additional suitable information, or any combination thereof.

At block 206 of the process 200, the processing system may send instructions (e.g., object-specific instructions) to activate a respective object emitter of the best candidate interactive object. At block 208 of the process 200, the processing system may receive and process hyperspectral data from a hyperspectral imaging system to confirm presence and/or identify of the best candidate interactive object, and/or to determine a position of the best candidate interactive object, based on the light emitted by the respective object emitter.

At block 210 of the process 200, the processing system may send instructions to activate one or more emitters to emit light that corresponds to a retroreflector wavelength relevant of a respective detectable marker of the best candidate interactive object. The one or more emitters may be activated to emit the light within a specific spectral region, such as IR light matching the retroreflector wavelength. The respective detectable marker may include a retroreflector to reflect the light emitted by the one or more emitters.

At block 212 of the process 200, the processing system may receive and process hyperspectral data from the hyperspectral imaging system to track motion of the best candidate interactive object in the interactive environment based on the light reflected by the respective detectable marker. For example, even if additional interactive objects and/or other objects reflect light, the processing system may continue to identify and separately track the light reflected by the respective detectable marker of the best candidate interactive object (e.g., a trail of reflections during motion) since the best candidate interactive object has been initially tagged in the hyperspectral data based on the position derived from the hyperspectral data as described in block 208 of the process 200. In an embodiment, the best candidate interactive object may be tracked simultaneously with one or more additional interactive objects. For example, the best candidate interactive object may be one of multiple interactive objects identified and tracked within the hyperspectral data. Each interactive object may be labeled based on a spectral signature and/or a trajectory of the interactive object in time. The hyperspectral data may be acquired using a snapshot type, a pushbroom type, a video type, and/or one or more additional types of hyperspectral detectors. The hyperspectral data may include one or more hyperspectral data cubes of an area of interest within the interactive environment. The hyperspectral data cubes may include data related to spatial, spectral, and/or temporal information within the area of interest.

While only certain features of the disclosed technology have been illustrated and described herein, many modifications and changes will occur to those skilled in the art. Further, any features described or shown with reference to FIGS. 1-5 may be combined in any suitable manner. For example, the hyperspectral imaging system may use light emitted by the object emitters (e.g., periodically and/or continuously, at least over certain and/or instructed time periods; in additional to and/or instead of light reflected by the detectable markers) to track motion of the interactive objects. It is, therefore, to be understood that the appended claims are intended to cover all such modifications and changes as fall within the true spirit of the disclosure. Furthermore, although the steps of the disclosed flowchart/s are shown in a given order, in certain embodiments, the depicted steps may be reordered, altered, deleted, and/or occur simultaneously.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. An interactive object control system, comprising:
processing circuitry comprising one or more processors; and
memory storing instructions, that when executed by the processing circuitry, cause the processing circuitry to:
send instructions to activate one or more emitters of an interactive object to emit light;
determine an initial position of the interactive object based on hyperspectral data from a hyperspectral imaging system, wherein the hyperspectral data is indicative of detection of the light emitted by the one or more emitters of the interactive object;
track motion of the interactive object based on additional hyperspectral data from the hyperspectral imaging system, wherein the additional hyperspectral data is indicative of detection of reflected light reflected by one or more detectable markers of the interactive object; and
provide output instructions to generate a special effect output based on the motion of the interactive object.

2. The interactive object control system of claim 1, wherein the hyperspectral data comprises a three-dimensional hyperspectral data cube comprising two-dimensional spatial data and one-dimensional spectral information within a field of view corresponding to at least a portion of an area of interest within an interactive environment.

3. The interactive object control system of claim 1, wherein the hyperspectral data comprises a four-dimensional hyperspectral data cube comprising two-dimensional spatial data, one-dimensional spectral information within a field of view corresponding to at least a portion of an area of interest within an interactive environment, and one-dimensional temporal information.

4. The interactive object control system of claim 1, wherein the instructions, when executed by the processing circuitry, cause the processing circuitry to track a retroreflector wavelength range of the one or more detectable markers.

5. The interactive object control system of claim 4, comprising one or more additional emitters separate from the interactive object, wherein the one or more additional emitters are configured to emit light within an infrared (IR) wavelength range that corresponds to the retroreflector wavelength range of the one or more detectable markers.

6. The interactive object control system of claim 4, wherein the retroreflector wavelength range is about 400 to 2800 nanometers (nm).

7. The interactive object control system of claim 4, wherein the retroreflector wavelength range is about 900 to 1700 nanometers (nm).

8. The interactive object control system of claim 1, wherein the instructions, when executed by the processing circuitry, cause the processing circuitry to:
acquire, via the hyperspectral imaging system, the hyperspectral data as a function of time as a series of hyperspectral data cubes of an area of interest; and
extract positional data in the series of hyperspectral data cubes to track the motion of the interactive object.

9. The interactive object control system of claim 8, wherein the hyperspectral data of as a function of time is acquired via compressive sensing techniques.

10. The interactive object control system of claim 1, wherein the instructions, when executed by the processing circuitry, cause the processing circuitry to:
detect a presence of a plurality of interactive objects in an interactive environment, wherein the plurality of interactive objects comprises the interactive object as a first interactive object of the plurality of interactive objects;
identify the first interactive object of the plurality of interactive objects as a best candidate object of the plurality of interactive objects in the interactive environment based on respective signal strengths of one or more RF signals the plurality of interactive objects; and
send, in response to identifying the first interactive object of the plurality of interactive objects as the best candidate object of the plurality of interactive objects, object-specific instructions to the first interactive object of the plurality of interactive objects to cause a respective output device of the first interactive object of the plurality of interactive objects to emit light without causing any respective output devices of a remainder of the interactive objects of the plurality of interactive objects to emit light.

11. A method of operating an interactive object system, the method comprising:
sending instructions to activate one or more emitters of an interactive object to emit light;
determining an initial position of the interactive object based on hyperspectral data from a hyperspectral imaging system, wherein the hyperspectral data is indicative of detection of the light emitted by the one or more emitters of the interactive object;
tracking motion of the interactive object based on additional hyperspectral data from the hyperspectral imaging system, wherein the additional hyperspectral data is indicative of detection of reflected light reflected by one or more detectable markers of the interactive object; and
providing output instructions to generate a special effect output based on the motion of the interactive object.

12. The method of claim 11, wherein the hyperspectral data comprises a three-dimensional hyperspectral data cube comprising two-dimensional spatial data and one-dimensional spectral information within a field of view corresponding to at least a portion of an area of interest within an interactive environment.

13. The method of claim 11, comprising:
acquiring, via the hyperspectral imaging system, the hyperspectral data as a function of time as a series of hyperspectral data cubes of an area of interest; and
extracting positional data from the series of hyperspectral data cubes to track the motion of the interactive object.

14. The method of claim 11, comprising:
receiving a unique identifier from the interactive object;
accessing a profile associated with the interactive object based on the unique identifier; and
providing the output instructions to generate the one or more special effect outputs based on the motion of the interactive object and information in the profile.

15. The method of claim 11, comprising:
detecting a presence of a plurality of interactive objects in an interactive environment, wherein the plurality of interactive objects comprises the interactive object as a first interactive object of the plurality of interactive objects;
identifying the first interactive object of the plurality of interactive objects as a best candidate object of the plurality of interactive objects in the interactive environment based on respective signal strengths of one or more RF signals the plurality of interactive objects; and
sending, in response to identifying the first interactive object of the plurality of interactive objects as the best candidate object of the plurality of interactive objects, object-specific instructions to the first interactive object of the plurality of interactive objects to cause a respective output device of the first interactive object of the plurality of interactive objects to emit light without causing any respective output devices of a remainder of the interactive objects of the plurality of interactive objects to emit light.

16. The method of claim 11, comprising tracking a retroreflector wavelength range of the one or more detectable markers.

17. The method of claim 16, comprising one or more additional emitters separate from the interactive object, wherein the one or more additional emitters are configured to emit light within an infrared (IR) wavelength range that corresponds to the retroreflector wavelength range of the one or more detectable markers.

18. The method of claim 16, comprising:
identifying and labeling each interactive object of the plurality of interactive objects; and
simultaneously tracking a position of each of the labeled interactive objects.

19. A system, comprising:
a hyperspectral imaging system comprising one or more detectors;
an interactive object system comprising an interactive object, wherein the interactive object comprises one or more detectable markers;
processing circuitry comprising one or more processors; and
memory storing instructions, that when executed by the processing circuitry, cause the processing circuitry to:
send instructions to activate one or more emitters to emit light within a spectral signature of the one or more detectable markers;
determine an initial position of the interactive object based on hyperspectral data indicative of detected light reflected by the one or more detectable markers;
track motion of the interactive object based on additional hyperspectral data generated indicative of the spectral signature of the one or more detectable markers; and
provide output instructions to generate a special effect output based on the motion of the interactive object.

20. The system of claim 19, comprising an interactive device configured to provide the special effect based on the output instructions.

21. The system of claim 19, wherein the one or more detectors of the hyperspectral imaging system comprise an indium gallium arsenide (InGaAs) sensor.
